(19) United States
(12) Patent Application Publication
(10) Pub. No.: US 2016/0156013 A1
(43) Pub. Date: Jun. 2, 2016

(54) LAMINATION, AND METHOD OF MANUFACTURING LAMINATION

(71) Applicant: NHK SPRING CO., LTD., Kanagawa (JP)

(72) Inventors: Yuichiro Yamauchi, Kanagawa (JP); Masaru Akabayashi, Kanagawa (JP); Shinya Miyaji, Kanagawa (JP)

(73) Assignee: NHK Spring Co., Ltd., Kanagawa (JP)

(21) Appl. No.: 14/903,433

(22) PCT Filed: Jun. 26, 2014
(86) PCT No.: PCT/JP2014/067070

§ 371 Date: Jan. 7, 2016

(30) Foreign Application Priority Data
Jul. 8, 2013 (JP) 2013-143032

(51) Int. Cl. H01M 2/30; C23C 4/12

(52) U.S. Cl. CPC H01M 2/30; C23C 4/12

(57) ABSTRACT

A lamination includes: a substrate made of a metal or an alloy; an intermediate layer formed on a surface of the substrate and made of nickel or an alloy including nickel; and a metal film formed by accelerating, towards a surface of the intermediate layer, a powder material of aluminum or an aluminum alloy together with a gas heated to a temperature lower than a melting point of the powder material and spraying the powder material in a solid phase to the intermediate layer and causing the powder material to be deposited on the intermediate layer.

### FIELD

The present invention relates to a lamination and a method of manufacturing the lamination.

### BACKGROUND

In recent years, cold spraying, for depositing a material powder on a substrate to coat the substrate by spraying the material powder at high temperature and high velocity onto the substrate, has received a lot of attention, as one type of thermal spraying. In cold spraying, a film is formed on a surface of a substrate by spraying, through a convergent-divergent (Laval) nozzle, a material to be the film, together with an inert gas heated to a temperature of equal to or less than the melting point or softening point of powder of the material, and causing the material still remaining in its solid phase to impinge on the substrate, and thus a metal film, free of phase transformation and with reduced oxidization, is able to be obtained.

Techniques related to cold spraying have been disclosed, including a technique, in which a material powder is sprayed after temperature of a substrate is controlled to a predetermined temperature (for example, see Patent Literature 1), and a technique, in which temperature of a substrate and/or an inert gas is controlled to form a metal film (for example, see Patent Literature 2).

Further, it has been disclosed that, by using stainless steel as a substrate and forming a metal film by cold spraying after controlling temperature of the stainless steel substrate within a predetermined range, adhesion strength between the stainless steel substrate and the film is improved (for example, see Patent Literature 3).

Furthermore, a technique has also been disclosed, in which an intermediate layer made of a metal or an alloy, which is softer than a substrate, is formed on a surface of the substrate, and a metal film is formed on a surface of the intermediate layer by cold spraying (for example, see Patent Literature 4).

### CITATION LIST

### Patent Literature

Patent Literature 1: Japanese Patent Application Laid-open No. 2008-302317

Patent Literature 2: Japanese Patent Application Laid-open No. 2008-127676

Patent Literature 3: Japanese Patent Application Laid-open No. 2012-187481

Patent Literature 4: Japanese Patent Application Laid-open No. 2012-219304

### SUMMARY

### Technical Problem

However, in Patent Literatures 1 and 2, although aluminum is described as an example of the material powder, there is no description with respect to any actual example of forming a film by using aluminum or to any intermediate layer, and there is no description nor suggestion with respect to any relation between: types and hardness of the substrate (intermediate layer) in formation of the aluminum film; and adhesiveness between the substrate and the film.

Moreover, in Patent Literature 3, there is no description with respect to any intermediate layer, and there is no description nor suggestion with respect to any relation between: types and hardness of the substrate (intermediate layer) in formation of the aluminum film; and adhesiveness between the substrate and the film.

In addition, according to Patent Literature 4, when the film is formed by cold spraying, adhesion between the substrate and the film is improved due to the anchor effect when the substrate is softer, but sometimes, a film having sufficient adhesiveness is unable to be obtained even if hardness of the substrate is small in forming a metal film by using powder of aluminum or an aluminum alloy.

The present invention has been made in view of the above, and an object thereof is to provide a lamination and a method of manufacturing the lamination, in forming a film made of aluminum or an aluminum alloy on a substrate by cold spraying, the lamination having high adhesiveness between the substrate and the film.

### Solution to Problem

To solve the problem and achieve the object, a lamination according to the present invention includes: a substrate made of a metal or an alloy; an intermediate layer formed on a surface of the substrate and made of nickel or an alloy including nickel; and a metal film formed by accelerating, towards a surface of the intermediate layer, a powder material of aluminum or an aluminum alloy together with a gas heated to a temperature lower than a melting point of the powder material and spraying the powder material in a solid phase to the intermediate layer and causing the powder material to be deposited on the intermediate layer.

Moreover, in the above-described lamination according to the present invention, the intermediate layer has Vickers hardness equal to or greater than 100 Hv.

Moreover, in the above-described lamination according to the present invention, the intermediate layer is a nonelectrolytically plated nickel layer.

Moreover, in the above-described lamination according to the present invention, the substrate is made of copper, and is used as a negative terminal for a battery.

Moreover, in the above-described lamination according to the present invention, the lamination is used as a negative terminal for a battery that is connected to a positive terminal of another battery via bus bar made of aluminum.

Moreover, a method of manufacturing a lamination according to the present invention includes: an intermediate layer forming step of forming an intermediate layer made of nickel or an alloy including nickel on an end face of a substrate made of a metal or an alloy; and a metal film forming step of: accelerating, towards a surface of the intermediate layer, a powder material of aluminum or an aluminum alloy together with a gas heated to a temperature lower than a melting point of the powder material; and spraying the powder material in a solid phase onto the substrate via the intermediate layer to cause the powder material to be deposited thereon and form a metal film.

### Advantageous Effects of Invention

For the lamination and the method of manufacturing the lamination according to the present invention, since an intermediate layer made of nickel or an alloy including nickel is on a substrate made of a metal or an alloy, a lamination is able to be obtained, the lamination having high adhesion strength between the substrate and a film made of aluminum or an aluminum alloy formed by cold spraying on the substrate via the intermediate layer.

### BRIEF DESCRIPTION OF DRAWINGS

FIG. 1 is a schematic diagram illustrating a structure of a lamination according to an embodiment of the present invention.

FIG. 2 is a schematic diagram illustrating a secondary battery using the lamination according to the embodiment of the present invention.

FIG. 3 is a top view illustrating connection, via an aluminum-made bus bar, between the secondary batteries using the laminations according to the embodiment of the present invention.

FIG. 4 is a schematic diagram illustrating an outline of a cold spray apparatus used in manufacture of the lamination according to the embodiment of the present invention.

FIG. 5 illustrates a schematic diagram of a test by a simple tensile test method.

FIG. 6 is a diagram illustrating a relation between hardnesses of nickel as substrates or intermediate layers and adhesion strengths of aluminum film layers, according to the simple tensile test method.

FIG. 7 is a diagram illustrating adhesion strengths of aluminum film layers in test pieces obtained by forming, as intermediate layers, nonelectrolytically (or electrolytically) plated nickel on various substrates, according to the simple tensile test method.

### DESCRIPTION OF EMBODIMENTS

Hereinafter, a mode for carrying out the present invention will be described in detail, together with the drawings. The present invention is not limited by the following embodiment. Further, each drawing referred to in the following description schematically illustrates shapes, sizes, and positional relations merely to an extent that allows contents of the present invention to be understood. That is, the present invention is not limited only to the shapes, sizes, and positional relations exemplified by each drawing.

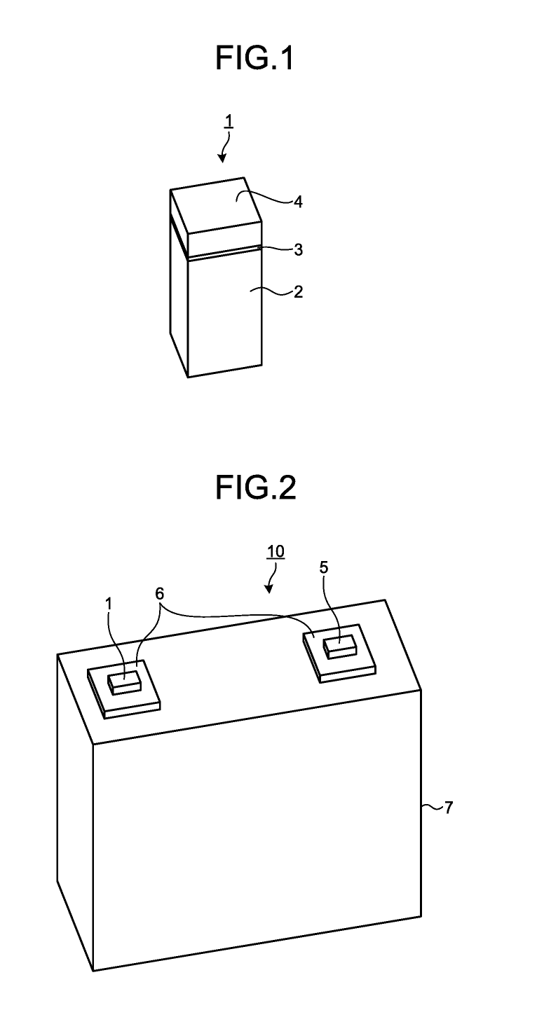

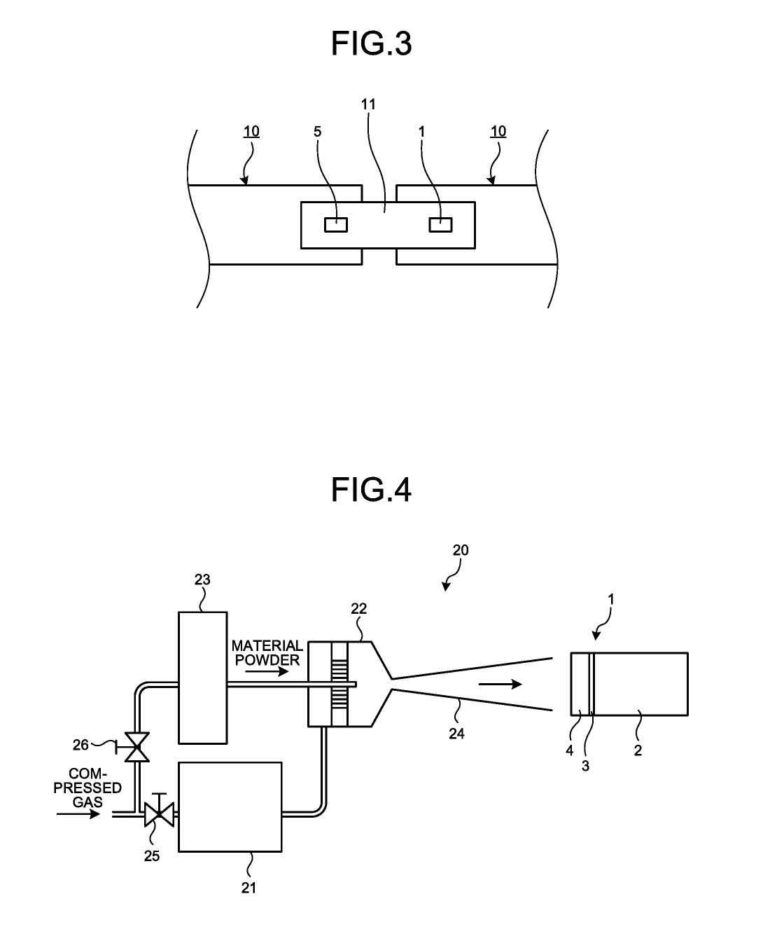

First, a method of manufacturing a lamination according to the embodiment of the present invention will be described in detail, with reference to the drawings. FIG. 1 is a schematic diagram illustrating a structure of the lamination according to the embodiment of the present invention. FIG. 2 is a schematic diagram of a secondary battery using the lamination according to the embodiment of the present invention. FIG. 3 is a top view illustrating connection, via an aluminum-made bus bar, between the secondary batteries using the laminations according to the embodiment of the present invention.

A lamination 1 is formed of: a substrate 2 made of a metal or an alloy; an intermediate layer 3 formed on a surface of the substrate 2 and made of nickel or an alloy including nickel; and a metal film 4 made of aluminum or an aluminum alloy formed by later described cold spraying via the intermediate layer 3. When the lamination 1 is used as an electrode terminal of the secondary battery illustrated in FIG. 2, the lamination 1 preferably has a rectangular column shape, but not being limited thereto, the lamination 1 may have a column shape, a polygonal column shape, or the like.

According to this embodiment, the intermediate layer 3 is nickel or an alloy including nickel. Examples of a nickel alloy usable as the intermediate layer 3 include: in addition to Monel, Hastelloy, Nichrome, Inconel (600, 625, 718, X750, etc.), constantan, Duranickel, permalloy, Kovar, Alumel, Chromel, Invar, elinvar, and the like; stainless steel containing nickel (301, 303, 304, 305, 309S, 310S, 312L, 315J1, 316, 317, 321, 329J, 630, 836L, 890L, etc.).

It is generally known that in forming a film by cold spraying, adhesiveness between a substrate and the film is improved due to the anchor effect when the substrate is softer, but in forming a metal film by using powder of aluminum or an aluminum alloy, sometimes a film having sufficient adhesiveness is unable to be obtained even if hardness of the substrate is small.

The reason for the small adhesiveness between the substrate and the aluminum film in spite of the obtained anchor effect is considered to be that due to presence of an oxide film on a surface of the aluminum or aluminum alloy powder, metallic bonding between the substrate and the metal film is hindered.

The inventors have found that by forming the intermediate layer 3, which has a large hardness and is made of nickel or an alloy including nickel, on the surface of the substrate 2, adhesion strength at a boundary surface between the substrate 2 and the metal film 4 is able to be improved via the intermediate layer 3. A mechanism of the improvement in the adhesiveness of the metal film 4 by the formation of the intermediate layer 3 on the surface of the substrate 2 is presumed to be that, when a powder material made of aluminum or an aluminum alloy is sprayed onto a surface of the intermediate layer 3 made of nickel or an alloy including nickel by cold spraying, due to impingement thereof on the intermediate layer 3 having the large hardness, an oxide film on the surface of the aluminum or aluminum alloy powder tends to be peeled off to generate a nascent surface thereon, and due to the presence of the intermediate layer 3 made of nickel or the alloy including nickel, formation of metallic bonds with aluminum or the like, from which the oxide film has been removed, is facilitated.

More preferably, in order to improve the adhesion strength at the boundary surface between the substrate 2 and the metal film 4, the Vickers hardness of the nickel or the alloy including nickel used as the intermediate layer 3 is equal to or greater than 100 Hv. This is presumed to be because if the Vickers hardness of the nickel or the alloy including nickel used as the intermediate layer 3 is equal to or greater than 100 Hv, when the aluminum or aluminum alloy powder impinges on the intermediate layer 3, the proportion of the peeling of the oxide film is increased even more.

Examples of a method of forming the intermediate layer 3 on the surface of the substrate 2 include plating, sputtering, vacuum deposition, and cold spraying, and the intermediate layer 3 of low cost and high hardness is able to be formed. The intermediate layer 3 is preferably formed by electroless nickel plating.

Thickness of the intermediate layer 3 is preferably equal to or greater than 1 μm. If the thickness is less than 1 μm, the oxide film on the surface of the aluminum or aluminum alloy powder is not sufficiently removed, and formation of metallic bonds is unable to be expected. Further, an upper limit of the thickness of the intermediate layer 3 is not particularly limited, but in terms of productivity and the like, the upper limit may be selected as appropriate according to the method of forming the intermediate layer 3, and the like. For example, if the intermediate layer 3 is formed by plating, sputtering, vacuum deposition, or the like, the thickness is preferably equal to or less than 100 μm, and if the intermediate layer 3 is formed by cold spraying, the thickness is preferably equal to or less than 5 mm although this differs depending on functions of the apparatus.

In this embodiment, the substrate 2 is made of a metal or an alloy, and a material thereof is not to be limited. The material of the substrate 2 is preferably a metal or an alloy having the Vickers hardness of less than 100 Hv, because by forming the intermediate layer 3 made of nickel or the nickel alloy, the adhesiveness of the metal film 4 made of aluminum or the aluminum alloy is able to be improved.

Further, if the material of the substrate 2 is a metal, on which an oxide film is formed in the air, or if the material is an alloy of that metal, by forming the intermediate layer 3 made of nickel or the nickel alloy, the adhesiveness of the metal film 4 made of aluminum or the aluminum alloy is able to be improved. Examples of the metal, on which the oxide film is formed in the air, include titanium, tungsten, and chromium.

If copper or a copper alloy is selected as the material of the substrate 2, since for the lamination 1 according to this embodiment, nickel or an alloy including nickel is used, which has an ionization tendency of a value between that of aluminum, which is the material of the metal film 4, and that of copper, which is the material of the substrate 2, an effect of being able to decrease the standard electrode potential difference and to suppress occurrence of any electrochemical reaction is achieved, too.

If copper is used as the material of the substrate 2, the lamination 1 according to this embodiment is able to be used as a negative electrode terminal of a secondary battery 10 illustrated in FIG. 2. The secondary battery 10 illustrated in FIG. 2 has a nonaqueous electrolyte filled in an outer container 7 thereof in a liquid-tight manner, and has a wound structure in a state where a separator is interposed between a positive plate and a negative plate.

The lamination 1, which is used as the negative terminal, is installed such that a metal film 4 side thereof protrudes outside the outer container 7. A positive terminal 5 is made of aluminum or an aluminum alloy, and similarly to the lamination 1, the positive terminal 5 is installed such that one end portion thereof protrudes outside the outer container 7. Insulators 6 are respectively arranged between the lamination 1 and the outer container 7, and between the positive terminal 5 and the outer container 7. The lamination 1 is connected to the negative plate and the positive terminal 5 is connected to the positive plate, respectively, by caulking, welding, or the like.

If the secondary battery 10 is used for purposes requiring large electric power, such as for automobiles or power sources for electric power storage, more than one secondary battery 10 is used by being connected to one another via conductive members called bus bars. When the secondary battery 10 is connected to be used as electric power for a large power source, as illustrated in FIG. 3, the lamination 1 used as the negative terminal thereof is connected to a positive terminal 5 of another secondary battery 10 via an aluminum made bus bar 11. The connection between an end portion of the aluminum made bus bar 11 and the lamination 1 having the metal film 4 made of aluminum or the aluminum alloy, and the connection between the other end portion of the aluminum made bus bar 11 and the positive terminal 5 made of aluminum or the aluminum alloy are able to be achieved under the same condition, for example, by soldering for aluminum connection, or the like. Therefore, when the laminations 1 according to this embodiment are used as the negative terminals, by using the same connection material, the connections are able to be performed at the same time. Further, a total weight of a battery for a large power source formed of plural secondary batteries 10 connected via aluminum bus bars 11 is able to be reduced largely. Furthermore, since for the lamination 1 according to this embodiment, the metal film 4 is formed by cold spraying, resistance at the boundary surface between the substrate 2 and the metal film 4 is able to be reduced remarkably.

Next, manufacture of the lamination 1 according to this embodiment will be described. The lamination 1 is able to be manufactured by, after forming the intermediate layer 3 made of nickel or an alloy including nickel, on an end face of the substrate 2 made of a metal or an alloy, accelerating, towards a surface of the intermediate layer 3, a powder material of aluminum or an aluminum alloy, together with a gas heated to a temperature lower than a melting point of the powder material, to be sprayed onto and deposited on the substrate 2, while the powder material is still in a solid phase, to form the metal film 4 on the substrate 2 via the intermediate layer 3.

The intermediate layer 3 is formed by forming, on the surface of the substrate 2, nickel or the nickel alloy, by plating, sputtering, vacuum deposition, cold spraying, or the like. The intermediate layer 3 of low cost and high hardness is able to be formed by electroless nickel plating.

The formation of the metal film 4 on the end face of the substrate 2 formed with the intermediate layer 3 is performed by cold spraying. The formation of the metal film 4 will be described with reference to FIG. 4. FIG. 4 is a schematic diagram illustrating an outline of a cold spray apparatus 20 used in the formation of the metal film 4.

The cold spray apparatus 20 includes: a gas heater 21 that heats up a compressed gas; a powder supply apparatus 23 that houses the material powder to be sprayed onto the substrate 2, and supplies the material powder to a spray gun 22; and a gas nozzle 24, through which the material partial pressure mixed with the compressed gas heated in the spray gun 22 is sprayed onto the substrate 2.

Helium, nitrogen, air, or the like is used as the compressed gas. The compressed gas to be supplied is supplied to the gas heater 21 and the powder supply apparatus 23 through valves 25 and 26, respectively. After the compressed gas supplied to the gas heater 21 is heated up to a temperature, for example, equal to or higher than 50° C. and equal to or lower than the melting point of aluminum or the aluminum alloy, which is the material powder of the metal film layer 4, the compressed gas is supplied to the spray gun 22. The compressed gas is preferably heated up to a temperature of 150 to 350° C.

The compressed gas supplied to the powder supply apparatus 23 supplies the material powder, which is in the powder supply apparatus 23, has a particle diameter of, for example, about 10 to 100 μm, and is made of aluminum or the aluminum alloy, to the spray gun 22 at a predetermined discharge rate. The heated compressed gas is made into a supersonic flow (of about 340 m/s or more) through the gas nozzle 24 having a convergent-divergent shape. Further, a gas pressure of the compressed gas is preferably about 1 to 5 MPa. By setting the pressure of the compressed gas to about 1 to 5 MPa, the adhesion strength between the substrate 2 and the metal film 4 is able to be improved. The treatment is preferably performed under a pressure of about 2 to 4 MPa. The material powder supplied to the spray gun 22 is accelerated through introduction into the supersonic flow of this compressed gas to impinge on the substrate 2 having the intermediate layer 3 thereon at high velocity, while remaining in the solid phase, to form the metal film. Any apparatus, which is able to form the metal film 4 by causing the material powder made of aluminum or the aluminum alloy to impinge, in the solid phase, on the substrate 2, may be used, not being limited to the cold spray apparatus 20 in FIG. 4.

### EXAMPLES

### Experimental Example 1

Aluminum particles (A1050 with a particle diameter of 30 μm) were sprayed with a compressed gas of nitrogen, a compressed gas temperature of 250° C., and a gas pressure of 5 MPa, onto substrates 12 made of various materials (50 mm×50 mm×3 mm; substrate types: Inconel 600, SUS 430, SUS 304, tungsten, titanium, bulk nickel, and C1020) by use of the cold spray apparatus 20, to form aluminum films 13 of a thickness of 700 μm to thereby obtain test pieces 14.

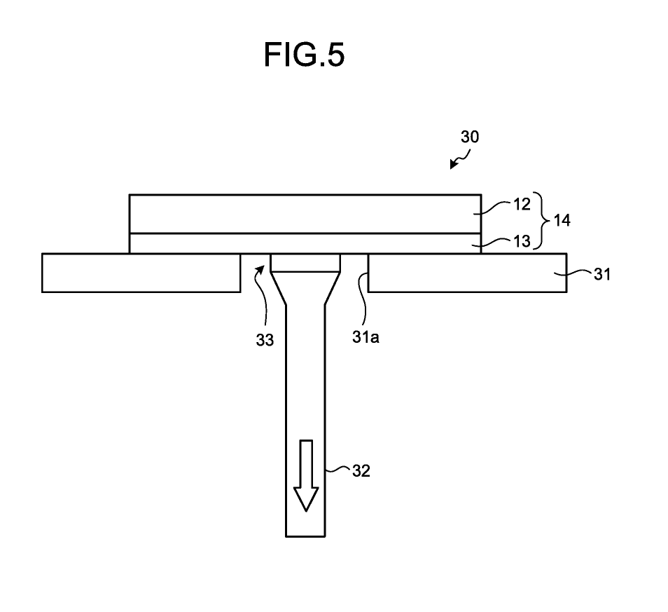

For the test pieces 14 made in the above described manner, adhesion strengths between the substrates 12 and the aluminum films 13 were evaluated by a tensile strength test method. FIG. 5 illustrates a schematic diagram of a test by a simple tensile test method applied to this example. In this method, after an aluminum pin 32 was bonded, via an adhesive 33, to the aluminum film 13 formed on the substrate 12, and the aluminum pin 32 bonded with the aluminum film 13 via the adhesive 33 was inserted into a hole portion 31a of a fixing stage 31 from above, the aluminum pin 32 was pulled downward, to thereby evaluate the adhesive strength between the substrate 12 and the aluminum film 13. The evaluation was made based on a tensile stress and a peeled state at a time point when the bonding was peeled. Table 1 below lists Vickers hardnesses (Hv) and results of the evaluation of the tensile test according to the differences among the substrates 12. The Vickers hardnesses of the substrates 12 were measured by FM-ARS6000 manufactured by Future-Tech Corp.

TABLE 1

| | | Adhesion |
|---|---|---|
| | Vickers Hardness | Strength |
| | [Hv] | [MPa] |
| Inconel 600 | 144.3 | 40 |
| SUS 430 | 145.5 | 4 |
| SUS 304 | 184 | 36 |
| Tungsten | 510 | 4 |
| Titanium | 165 | 17 |
| Bulk Nickel | 80.9 | 20 |
| Copper (C1020) | 74.7 | 17 |

As listed in Table 1, it has been confirmed that the adhesion strength at the boundary surface with the aluminum film 13 was high when bulk nickel, Inconel 600, and SUS 304, each of which is nickel or an alloy including nickel, were selected as the substrate 12. The adhesion strength of SUS 430 was found to be low although SUS 430 had a hardness that is about the same as that of Inconel 600. This is presumed to be because SUS 430 does not contain nickel. From these results, it has been found that excellent adhesion strength tends to be obtained between aluminum, and nickel or an alloy including nickel. Further, it was confirmed that although the hardness of tungsten and titanium was high, the adhesion strength at the boundary surface between the substrate 12 and the aluminum film 13 was small. This is considered to be because due to the oxide films on the tungsten and titanium surfaces, metallic bonds with aluminum are hard to be formed.

### Experimental Example 2

Intermediate layers of electrolytically plated nickel or nonelectrolytically plated nickel, which had a thickness of 2 μm, were formed on surfaces of substrates 12 (50 mm×50 mm×3 mm) made of C1020 (hardness: 70 Hv), and aluminum particles (A1050 with a particle diameter of 30 μm) were sprayed with a compressed gas of nitrogen, a compressed gas temperature of 250° C., and a gas pressure of 5 MPa, onto surfaces of the intermediate layers by use of the cold spray apparatus 20, to form aluminum films 13 of a thickness of 700 μm to thereby obtain test pieces.

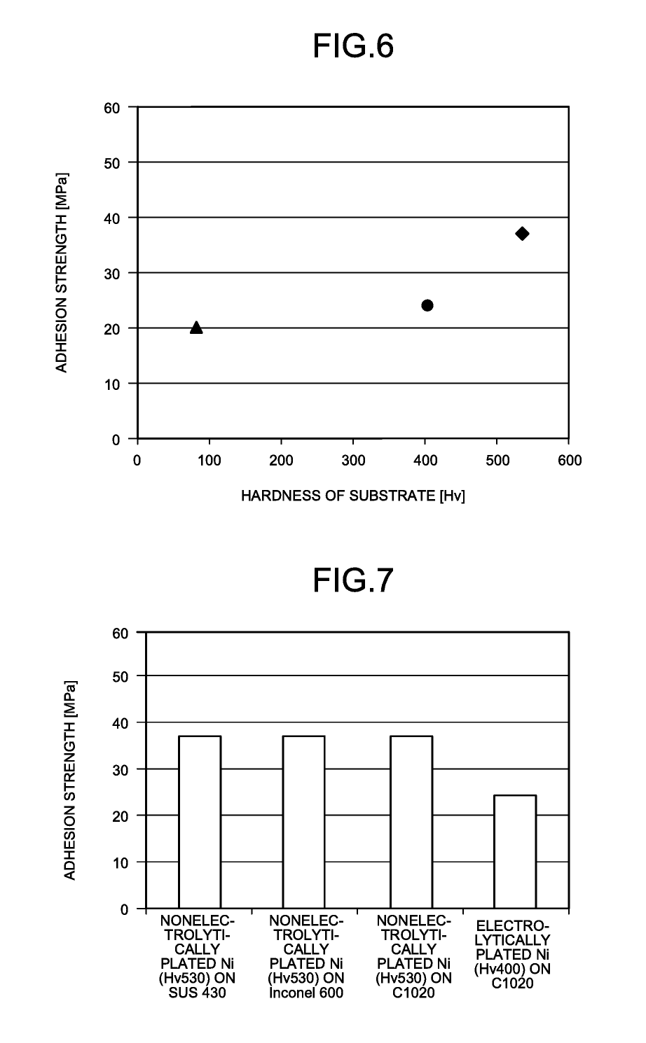

For the test pieces made in the above described manner, similarly to Experimental Example 1, adhesion strengths at boundary surfaces between the substrates 12 and the aluminum films 13 in the case where the intermediate layers were formed were evaluated by the simple tensile test method illustrated in FIG. 5. Table 2 below lists results of the evaluation in the tensile test according to the differences among the hardnesses of nickel as the substrates 12 or intermediate layers. Further, FIG. 6 illustrates a relation between the hardnesses of nickel as the substrates or intermediate layers and the adhesion strengths of the aluminum film layers. In FIG. 6, the filled triangle corresponds to the bulk nickel test piece, the filled circle to the electrolytically plated nickel test piece, and the filled rhombus to the nonelectrolytically plated nickel test piece. The Vickers hardness of the intermediate layer is a hardness in a case where the intermediate layer of a thickness of 5 μm is formed on a surface of the substrate 12, and was measured by FM-ARS6000 manufactured by Future Tech Corp.

TABLE 2

| | Vickers | Adhesion |
|---|---|---|
| | Hardness | Strength |
| | [Hv] | [MPa] |
| Bulk Ni | 80.9 | 20 |
| Electrolytically Plated Ni | 404 | 24 |
| Non-electrolytically Plated Ni | 535.4 | 37 |

As listed and illustrated in Table 2 and FIG. 6, it was confirmed that the higher the hardness of the substrate 12 or intermediate layer was, the higher the adhesion strength at the boundary surface between the substrate 12 and the aluminum film 13 became.

### Experimental Example 3

By selecting C1020 (hardness: 74.7 Hv), SUS 430 (hardness: 145.5 Hv), and Inconel 600 (hardness: 144.3 Hv) as substrates 12 (50 mm×50 mm×3 mm), intermediate layers of electrolytically plated nickel or nonelectrolytically plated nickel, which had a thickness of 2 μm, were formed on surfaces of the various substrates 12, and aluminum particles (A1050 with a particle diameter of 30 μm) were sprayed with a compressed gas of nitrogen, a compressed gas temperature of 250° C., and a gas pressure of 5 MPa, onto surfaces of the intermediate layers by use of the cold spray apparatus 20, to form aluminum films 13 of a thickness of 700 μm to thereby obtain test pieces.

For the test pieces made in the above described manner, similarly to Experimental Example 1, adhesion strengths at boundary surfaces between the substrates 12 and the aluminum films 13 were evaluated by the simple tensile test method illustrated in FIG. 5. FIG. 7 is a diagram illustrating the adhesion strengths of aluminum film layers in the test pieces obtained by forming, as the intermediate layers, nonelectrolytically (or electrolytically) plated nickel on the various substrates. The Vickers hardness of the intermediate layer is a hardnesses in a case where the intermediate layer of a thickness of 5 μm is formed on the surface of the substrate 12, and was measured by FM-ARS6000 manufactured by Future Tech Corp.

As illustrated in FIG. 7, it was confirmed that for each of the test pieces made by forming the intermediate layers of nonelectrolytically plated nickel of 2 μm on the substrates 12 formed of C1020 (hardness: 74.7 Hv), SUS 430 (hardness: 145.5 Hv), or Inconel 600 (hardness: 144.3 Hv) and forming the aluminum films 13 thereon by cold spraying, regardless of the hardnesses of the substrates 12, the adhesion strengths at the boundary surfaces between the substrates 12 and the aluminum films 13 were about the same. Although SUS 430 has a very small adhesion strength when the aluminum film 13 is directly formed by cold spraying (see Experimental Example 1), just by forming the intermediate layer of nonelectrolytically plated nickel thereon, the adhesion strength is able to be improved largely. Further, it is presumed that when an intermediate layer made of nickel or an alloy including nickel, which has high hardness, is formed by electroless nickel plating or the like on a surface of a substrate, such as titanium or tungsten, having small adhesion strength with respect to an aluminum film due to presence of an oxide film thereon, and an aluminum film is formed by cold spraying via the intermediate layer, the adhesion strength is also able to be improved largely.

### INDUSTRIAL APPLICABILITY

As described above, the lamination and the method of manufacturing the lamination according to the present invention is useful when an aluminum film is formed by cold spraying on a substrate made of a metal or an alloy.

### REFERENCE SIGNS LIST

1 LAMINATION

2, 12 SUBSTRATE

3 INTERMEDIATE LAYER

4, 13 METAL FILM

5 POSITIVE TERMINAL

6 INSULATOR

7 OUTER CONTAINER

10 SECONDARY BATTERY

11 ALUMINUM MADE BUS BAR

14 TEST PIECE

20 COLD SPRAY APPARATUS

21 GAS HEATER

22 SPRAY GUN

23 POWDER SUPPLY APPARATUS

24 GAS NOZZLE

30 TENSILE TEST APPARATUS

31 FIXING STAGE

31a HOLE PORTION

32 ALUMINUM PIN

33 ADHESIVE

1. A lamination comprising:
a substrate made of a metal or an alloy;
an intermediate layer formed on a surface of the substrate and made of nickel or an alloy including nickel; and
a metal film formed by accelerating, towards a surface of the intermediate layer, a powder material of aluminum or an aluminum alloy together with a gas heated to a temperature lower than a melting point of the powder material and spraying the powder material in a solid phase to the intermediate layer and causing the powder material to be deposited on the intermediate layer.

2. The lamination according to claim 1, wherein the intermediate layer has Vickers hardness equal to or greater than 100 Hv.

3. The lamination according to claim 1, wherein the intermediate layer is a nonelectrolytically plated nickel layer.

4. The lamination according to claim 1, wherein the substrate is made of copper, and is used as a negative terminal for a battery.

5. The lamination according to claim 4, wherein the lamination is used as a negative terminal for a battery that is connected to a positive terminal of another battery via bus bar made of aluminum.

6. A method of manufacturing a lamination, the method comprising:
an intermediate layer forming step of forming an intermediate layer made of nickel or an alloy including nickel on an end face of a substrate made of a metal or an alloy; and
a metal film forming step of: accelerating, towards a surface of the intermediate layer, a powder material of aluminum or an aluminum alloy together with a gas heated to a temperature lower than a melting point of the powder material; and spraying the powder material in a solid phase onto the substrate via the intermediate layer to cause the powder material to be deposited thereon and form a metal film.
